(19) United States
(12) Patent Application Publication
(10) Pub. No.: US 2012/0082772 A1
(43) Pub. Date: Apr. 5, 2012

(54) Method For Sterilization Of Food

(75) Inventors: Hiroshi Batori, Shizuoka-shi (JP); Tetsuya Takatomi, Sagamihara-shi (JP); Toshihiro Asano, Shizuoka-shi (JP); Hiroshi Urakami, Niigata-Shi (JP); Yukifumi Konagaya, Niigata-Shi (JP); Takateru Ishimori, Niigata-Shi (JP)

(73) Assignees: THE NIIGATA INSTITUTE OF SCIENCE AND TECHNOLOGY, Niigata-shi (JP); DAIWA CAN COMPANY, Tokyo (JP)

(21) Appl. No.: 13/166,113

(22) Filed: Jun. 22, 2011

(30) Foreign Application Priority Data
Sep. 30, 2010 (JP) 2010-220693

(51) Int. Cl. A23L 3/358; A23L 3/015

(52) U.S. Cl. 426/335

(57) ABSTRACT

The present invention provides a food sterilization method by which the effective sterilization of the spore-forming bacteria having high heat resistance and high pressure resistance is possible without impairing the taste, flavor, and texture of food. A method for sterilization of food comprising: high-pressure treatment step in which one or more amino acids selected from the group consisting of cysteine, alanine, methionine, phenylalanine, serine, leucine, and glycine is added to a sterilization target food, and then the sterilization target food including the amino acid is treated at 50 to 600 MPa for 1 to 120 minutes; and low-temperature heating step in which the sterilization target food is heated at 60 to 100° C. for 5 minutes or more after the high-pressure treatment step.

### RELATED APPLICATIONS

This application claims the priority of Japanese Patent Application No. 2010-220693 filed on Sep. 30, 2010, which are incorporated herein by reference.

### FIELD OF THE INVENTION

The present invention relates to a method for sterilization of food, and in particular, relates to sterilization of spore-forming bacteria, such as Clostridium botulinum, having highly heat- and pressure-resistant spores that present a food safety problem.

### BACKGROUND OF THE INVENTION

The sterilization of microorganisms by high-pressure treatment does not impair the taste, flavor, and texture of food unlike the high-heat sterilization at 100° C. or higher. In addition, the high-pressure sterilization is more energy-efficient than the heat sterilization; thus various high-pressure sterilization methods have been investigated. However, the spore-forming bacteria produce pressure-resistant spores, and it is difficult to sterilize the spores of such spore-forming bacteria by high-pressure sterilization alone. Thus, a combination of high-pressure treatment and heat treatment (Japanese unexamined patent publication No. H04-9170, H05-227925, and 2000-32965) and a combination of high-pressure treatment and the use of additives (Japanese unexamined patent publication No. H05-252920, 1108-182486, H05-227925, and 1106-70730) have been investigated.

By these high-pressure sterilization methods, it is possible to sterilize spore-forming bacteria, non-spore-forming bacteria, fungi, yeast, etc. that are not highly resistant against pressure. However, the spores produced by certain spore-forming bacteria have very high pressure resistance and heat resistance, and the satisfactory sterilization is not possible by the above-described conventional high-pressure treatment. Clostridium bacteria such as Clostridium botulinum are the most important microorganisms from the standpoint of food safety because they produce a strong neurotoxin, and they are the indicator bacteria for food sterilization. The spores formed by these Clostridium bacteria have very high pressure resistance, and their sterilization is very difficult to achieve by the high-pressure treatment.

In order to suppress the growth of spores of Clostridium bacteria such as Clostridium botulinum, the use of additives after high-pressure treatment has been proposed (Japanese unexamined patent publication No. H05-252920). However, this method only suppresses the growth of spores and the sterilization cannot be achieved; thus it is not satisfactory from a safety standpoint. On the other hand, it is possible to sterilize these spores by the combination of high-pressure treatment at about 1000 MPa and the high heat treatment at about 100° C. (Applied And Environment Microbiology, Vol. 72, No. 5, pp. 3476-3481, May 2006). However, the treatment equipment, with which the simultaneous high-pressure treatment and high heat treatment are possible, is limited to only small laboratory equipment at present. With large treatment equipment that is used for actual food manufacturing, it is difficult to realize the similar high-temperature and high-pressure conditions, and the cost in the actual use is also high. In addition, there is an issue in that the taste and texture of food may be impaired because of high-temperature and high-pressure treatment.

### DISCLOSURE OF THE INVENTION

### Problem to be Solved by the Invention

As explained above, it is difficult to satisfactorily sterilize the pressure-resistant and heat-resistant spores, which are formed, for example, by Clostridium bacteria such as Clostridium botulinum, by the conventional high-pressure sterilization method. In particular, there has been a safety problem in the use of the high-pressure sterilization method for the sterilization of low-acidity food. This is because the growth of such spores is possible in the low-acidity food. Thus, the problem to be solved in the present invention is to provide a food sterilization method by which the effective sterilization of the spore-forming bacteria having high heat resistance and high pressure resistance is possible without impairing the taste, flavor, and texture of food.

### Means to Solve the Problem

The present inventors have diligently studied in view of the above-described problem of the conventional art and have found the following. The spore-forming bacteria having high heat resistance and high pressure resistance can be effectively germinated by adding a specific amino acid such as cysteine into the food and carrying out high-pressure treatment at 50 to 600 MPa. The thus obtained spore-forming bacteria whose spores have been germinated can be effectively sterilized by the succeeding low-temperature sterilization at 60 to 100° C. Accordingly, the sterilization of the spore-forming bacteria having high heat resistance and high pressure resistance and difficult to sterilize by the conventional high-pressure treatment method can be satisfactorily sterilized without impairing the taste, flavor, and texture of food, thus leading to completion of the present invention.

That is, the method for sterilization of food in the present invention is characterized by comprising: high-pressure treatment step in which one or more amino acids selected from the group consisting of cysteine, alanine, methionine, phenylalanine, serine, leucine, and glycine is added to a sterilization target food, and then the sterilization target food including the amino acid is treated at 50 to 600 MPa for 1 to 120 minutes; and low-temperature heating step in which the sterilization target food is heated at 60 to 100° C. for 5 minutes or more after the high-pressure treatment step.

In the method, it is preferable that 0.01 to 0.15 mol of the amino acid relative to 1 L of the sterilization target food is added.

In the method, it is also preferable that alanine and/or cysteine is used as the amino acid.

In the method, it is also preferable that sodium hydrogencarbonate is added to the sterilization target food with the amino acid.

In the sterilization method, it is also preferable that 0.2 to 1.0 mol of the sodium hydrogencarbonate relative to 1 L of the sterilization target food is added.

In the sterilization method, it is also preferable that the sterilization target food contains less than 0.15 mol/l of amino acid in total before adding the amino acid.

In addition, the method for sterilization of food in the present invention is characterized by comprising: high-pressure treatment step in which sodium hydrogencarbonate is added to a sterilization target food containing 0.01 mol/L or more of amino acid in total, and then the sterilization target food including the sodium hydrogencarbonate is treated at 50 to 600 MPa for 1 to 240 minutes; and low-temperature heating step in which the sterilization target food is heated at 60 to 100° C. for 5 minutes or more after the high-pressure treatment step.

In the method, it is preferable that 0.2 to 1.0 mol of the sodium hydrogencarbonate relative to 1 L of the sterilization target food is added.

In the method of present invention, it is also preferable that spore-forming bacteria in the sterilization target food is sterilized.

In the method, it is also preferable that Clostridium bacteria in the sterilization target food is sterilized.

### Effect of the Invention

According to the food sterilization method of the present invention, the effective sterilization of spore-forming bacteria, having high heat resistance and high pressure resistance and difficult to sterilize by the conventional high-pressure treatment method, is possible without impairing the taste, flavor, and texture of food. The sterilization can be achieved by carrying out the high-pressure treatment at 50 to 600 MPa, in a state in which a specific amino acid such as cysteine is contained in the food, and the subsequent low-temperature sterilization treatment at 60 to 100° C.

### BRIEF DESCRIPTION OF THE DRAWINGS

FIG. 1 shows the summary of the test results for the sterilization effect by the high-pressure treatment at 100 MPa after the addition of 0.08 M amino acid (Example 1-1).

FIG. 2 shows the summary of the test results for the sterilization effect by the high-pressure treatment at 200 MPa after the addition of 0.08 M amino acid (Example 1-2).

FIG. 3 shows the summary of the test results for the sterilization effect by the high-pressure treatment at 400 MPa after the addition of 0.08 M amino acid (Example 1-3).

FIG. 4 shows the summary of the test results for the sterilization effect by the high-pressure treatment at 0.1 MPa after the addition of 0.08 M amino acid (Example 1-4).

FIG. 5 shows the summary of the test results for the sterilization effect by the high-pressure treatment at various pressures after the addition of an amino acid.

FIG. 6 shows the summary of the test results for the sterilization effect by the high-pressure treatment at 200 MPa and 45° C., by varying the treatment time, after the addition of an amino acid (Example 4-1).

FIG. 7 shows the summary of the test results for the sterilization effect by the high-pressure treatment at 200 MPa and 70° C., by varying the treatment time, after the addition of an amino acid (Example 4-2).

FIG. 8 shows the summary of the test results for the sterilization effect by the high-pressure treatment at 200 MPa and 45° C. for 120 minutes by varying the concentration of the added amino acid (Example 5-1).

FIG. 9 shows the summary of the test results for the sterilization effect by the high-pressure treatment at 200 MPa and 70° C. for 15 minutes by varying the concentration of the added amino acid (Example 5-2).

FIG. 10 shows the summary of the test results for the sterilization effect by the high-pressure treatment at 100 MPa and 70° C. for 15 minutes after the addition of an amino acid and sodium hydrogencarbonate (Example 6-1).

FIG. 11 shows the summary of the test results for the sterilization effect by the high-pressure treatment at 200 MPa and 70° C. for 15 minutes after the addition of an amino acid and sodium hydrogencarbonate (Example 6-2).

FIG. 12 shows the summary of the test results for the sterilization effect by the high-pressure treatment at 100 MPa and 70° C. for 15 minutes by varying the concentration of the added sodium hydrogencarbonate.

FIG. 13 shows the summary of the test results for the sterilization effect by the high-pressure treatment at 100 MPa and 70° C. for 15 minutes after the addition of sodium hydrogencarbonate to hashed beef rice (Example 8-1).

FIG. 14 shows the summary of the test results for the sterilization effect by the high-pressure treatment at 200 MPa and 70° C. for 15 minutes after the addition of sodium hydrogencarbonate to hashed beef rice (Example 8-2).

FIG. 15 shows the summary of the test results for the sterilization effect by the high-pressure treatment at 100 MPa and 70° C. for 15 minutes after the addition of an amino acid and sodium hydrogencarbonate to burdock (Example 8-3).

FIG. 16 shows the summary of the test results for the sterilization effect by the high-pressure treatment at 200 MPa and 70° C. for 15 minutes after the addition of an amino acid and sodium hydrogencarbonate to burdock (Example 8-4).

FIG. 17 shows the summary of the test results for the sterilization effect of Clostridium botulinum (62A: toxin A-producing strain) by the high-pressure treatment and heat treatment after the addition of an amino acid and sodium hydrogencarbonate (Example 9-1).

FIG. 18 shows the summary of the test results for the sterilization effect of Clostridium botulinum (213B: toxin B-producing strain) by the high-pressure treatment and heat treatment after the addition of an amino acid and sodium hydrogencarbonate (Example 9-2).

### BEST MODE FOR CARRYING OUT THE INVENTION

### DESCRIPTION OF THE PREFERRED EMBODIMENT

The present invention relates to spore-forming bacteria that are difficult to satisfactorily sterilize by the conventional high-pressure treatment method, in particular, relates to Clostridium bacteria, such as Clostridium botulinum, that pose a problem in food safety and have spores with very high heat resistance and pressure resistance. The invention was made by focusing especially on the germination of spores. That is, the spores formed by Clostridium bacteria, such as Clostridium botulinum, have very high heat resistance and pressure resistance; however, the spores do not multiply as they are and the metabolism is very small. However, the spores germinate in a favorable habitat and become vegetative cells that have normal metabolism and growth capability. In the state of spores, the heat resistance and pressure resistance are very high; thus the sterilization treatment is very difficult. However, the sterilization is possible by heating at a relatively low temperature in the state of germinated vegetative cells. Accordingly, if the spores formed by spore-forming bacteria are allowed to germinate efficiently, the spore-forming bacteria can be satisfactorily sterilized by low-temperature heat treatment.

In the sterilization method of the present invention, the spores formed by the spore-forming bacteria having high heat resistance and high pressure resistance can be efficiently germinated by carrying out the high-pressure treatment in a state in which a specific amino acid such as cysteine is contained. Then, the spore-forming bacteria whose spores have been germinated can be effectively sterilized by the heat treatment at a relatively low temperature. As a result, the satisfactory sterilization of spore-forming bacteria, having high heat resistance and high pressure resistance and very difficult to sterilize by the conventional high-pressure treatment method, is possible. In addition, the taste, flavor, and texture of food are not impaired because the high heat treatment is avoided.

Thus, the food sterilization method of the present invention is characterized by comprising the high-pressure treatment step, wherein one or more amino acids selected from the group consisting of cysteine, alanine, methionine, phenylalanine, serine, leucine, and glycine are added to the sterilization target food and then the treatment at 50 to 600 MPa is carried out for 1 to 120 minutes, and the low-temperature heating sterilization step, wherein the heating is carried out at 60 to 100° C. for 5 minutes or more after the high-pressure treatment step.

In the sterilization method of the present invention, the target is the food whose contamination by microorganisms, which include spore-forming bacteria, is a problem and the high-pressure treatment thereof is possible. The sterilization target food of the present invention is not limited in particular, and the examples include liquid food and semi-liquid food. Examples of the liquid food include foods containing non-viscous liquid, such as soft drink, carbonated drink, energy drink, consomme soup, minestrone, miso soup, and clear soup. Examples of the semi-liquid food include foods containing viscous liquid, such as curry, stew, rice gruel, ankake sauce, jelly, and fruit sauce. In the case of solid food, the uniform impregnation of amino acid inside the food is normally difficult; thus it is difficult to achieve satisfactory sterilization inside the food. However, if the sterilization is only for the outer surface of the food, the sterilization method of the present invention is applicable.

The pH of the sterilization target food is preferably in the range of 5.0 to 9.0. If the pH deviates from this range, namely, at low pH or high pH, the spores cannot be germinated and the sterilization effect could be markedly lower. In addition, the water activity of food is preferably 0.94 or higher. If the water activity is lower than this, the conditions suitable for the germination of spores cannot be generated, as is the case at low pH or high pH, and the sterilization effect may not be obtained.

### <High-Pressure Treatment Step>

In the sterilization method of the present invention, prior to the high-pressure treatment, a specific amino acid is added to the sterilization target food. Here, it is necessary to add and mix a specific amino acid so that the amino acid is uniformly distributed in the food. As the amino acid, any amino acid can be suitably selected from the group consisting of cysteine, alanine, methionine, phenylalanine, serine, leucine, and glycine. Besides, two or more of these amino acids can be used in combination. The amount of added amino acid is preferably 0.01 to 0.15 mol/L in the food. If the amount of added amino acid is less than 0.01 mol/L in the food, the spores cannot be efficiently germinated by the high-pressure treatment, and the satisfactory sterilization effect may not be achieved. On the other hand, even if more than 0.15 mol/L of the amino acid is added to the food, the sterilization effect cannot be improved any further, and rather a negative effect may be caused to the taste of food. The sterilization effect is depending on the kinds of amino acids, and the effective sterilization can be achieved in the order of cysteine, alanine, methionine, phenylalanine, leucine, serine, and glycine. When 0.15 mol/L or more of the amino acid is contained in the sterilization target food, the sterilization effect may not be further improved even by the addition of more amino acid. Thus, when the sterilization target food contains less than 0.15 mol/L of the amino acid, the advantageous improvement of the sterilization effect can be obtained.

Subsequently, the high-pressure treatment is carried out for the food in which the above-described specific amino acid is added. The high-pressure treatment is carried out at 50 to 600 MPa for 1 to 120 minutes. More preferably, the high-pressure treatment is carried out at 100 to 600 MPa for 10 to 120 minutes. If the pressure of the high-pressure treatment is lower than 50 MPa, the germination of spores will not be sufficient and the sterilization effect may not be satisfactory. On the other hand, if the pressure is too high, the germination tends to be suppressed. If the treatment is carried out at a pressure exceeding 600 MPa, the germination of spores is suppressed and the sterilization effect may not be satisfactory. In addition, the upper pressure limit of most equipment, which is presently commercially available for high-pressure food processing, is 600 MPa. Thus, the pressure treatment at 600 MPa or higher is not realistic. If the treatment time is less than 1 minute, the germination of spores will not be sufficient and the sterilization effect may not be satisfactory. On the other hand, even if the treatment time is more than 120 minutes, the further germination-promoting effect cannot be obtained. On the contrary, the treatment becomes too excessive, and the taste, flavor, and texture of food may be impaired.

The temperature during high-pressure treatment is preferably 40 to 80° C. If the temperature is less than 40° C., the spores of spore-forming bacteria may not germinate. On the other hand, if the temperature exceeds 80° C., the heat damage to food will be large, and the taste, flavor, and texture of food will be impaired. In addition, the equipment will be damaged and the energy loss will be large. The temperature during high-pressure treatment is suitably selected according to the amount, kinds, and the viscosity of the sterilization target food. In addition, it is preferable to heat the food, before the high-pressure treatment, up to the temperature of high-pressure treatment with the heating equipment such as a hot-water bath. The heating is continued until the desired temperature is reached at the center of the food. As the equipment for high-pressure treatment, any equipment can be used so far as the above-described pressure and temperature can be achieved.

In the sterilization method of the present invention, it is especially important to carry out the high-pressure treatment in the presence of the above-described specific amino acid. That is, the spore-forming bacteria, such as Clostridium bacteria, having high heat resistance and high pressure resistance can be efficiently germinated by carrying out the high-pressure treatment in the presence of the amino acid. The spores of spore-forming bacteria cannot be sufficiently germinated by the addition of the amino acid only or the high-pressure treatment only. Even if the amino acid is added after the high-pressure treatment, the spores cannot be effectively germinated, resulting in unsatisfactory sterilization.

In the sterilization method of the present invention, it is also preferable to add sodium hydrogencarbonate (NaHCO₃), to the sterilization target food, in addition to the above-described specific amino acid. The sterilization effect is further improved, compared with case in that the amino acid is used alone, by the addition of sodium hydrogencarbonate in addition to the amino acid. The amount of sodium hydrogencarbonate added to the food is preferably 0.2 to 1.0 mol/L. If the amount of added sodium hydrogencarbonate is less than 0.2 mol/L in the food, the sterilization effect may not be improved. On the other hand, if the amount of added sodium hydrogencarbonate is more than 1.0 mol/L in the food, a rather negative effect may result concerning the taste of food.

Even when 0.01 mol/L or more of the amino acid is contained in the sterilization target food, the sterilization effect will be improved by the high-pressure treatment after the addition of sodium hydrogencarbonate. Thus, when the sterilization target is the food that contains 0.01 mol/L or more of the amino acid, an excellent sterilization effect will be obtained by the above-described high-pressure treatment after the addition of sodium hydrogencarbonate. Such a sterilization method is also in the category of the present invention.

### <Low-Temperature Heating Step>

In the subsequent low-temperature heating sterilization step, the food treated in the high-pressure treatment step is heated at 60 to 100° C. for 5 minutes or more. More preferably, the heat treatment is carried out at 70 to 95° C. for 5 to 30 minutes. By the heat treatment at 60 to 100° C., the spore-forming bacteria whose spores have been germinated in the high-pressure treatment step can be satisfactorily sterilized. In addition, fungi, yeast, non-spore-forming bacteria, etc. can also be sterilized. The heating temperature and heating time are suitably determined according to the amount, kinds, and the viscosity of the sterilization target food. If the temperature is lower than 60° C. or the heating time is shorter than 5 minutes, the spore-forming bacteria whose spores have been germinated may not be satisfactorily sterilized. On the other hand, if the heat treatment is carried out at a temperature higher than 100° C., the heat damage to food will be large, and the taste, flavor, and texture of food will be impaired.

In addition, the shelf life can be improved by swiftly cooling the food to a suitable storage temperature after the low-temperature heating sterilization step. When time is necessary, for the convenience of manufacturing, until the low-temperature sterilization treatment after the high-pressure treatment, the food can be cooled and stored in a refrigerator for a few hours to 1 day after the high-pressure treatment. The low-temperature sterilization treatment after the storage can achieve a comparable sterilization effect.

In the sterilization method of the present invention, the high-pressure treatment and low-temperature heating sterilization of sterilization target food may be carried out in a pre-packed state in a container, or the sterilized food may be aseptically packed in a sterilized container after the completion of the entire process. It is normally preferable, for the convenience of manufacturing, to carry out the high-pressure treatment and low-temperature sterilization treatment of the food in a packed state in a container. That is, the sterilization target food is packed in a container, the above-described specific amino acid is added and mixed into the container, and the container is sealed. Then, the high-pressure treatment and low-temperature sterilization treatment are carried out to the container in which the food is enclosed.

When the high-pressure treatment and low-temperature sterilization treatment is used for the food pre-packed in the container, the container should be treatable by pressure. In the use of the container treatable by pressure, it is necessary for the external pressure to indirectly act on the food inside the container through the barrier. In addition, the container should not be perforated, destroyed, or melted by pressure. Because the low-temperature sterilization treatment is carried out subsequent to the high-pressure treatment, it is also necessary that the heat is transmitted to the food in the container, and the container should not be melted, perforated, or destroyed by heating. Specific examples of such containers include metal containers such as a can, in which the volume change by pressurization is allowable, and soft packaging containers such as a plastic cup and a pouch. In order to enable long-term storage, the containers having barrier properties against gas and light are preferable.

### EXAMPLES

Hereinafter, the present invention will be explained in further detail with reference to the examples of food sterilization methods. However, the present invention is not limited by these examples.

Initially, the test conditions and test methods used in the present examples will be explained.

### <Test Strain>

As the test bacterial strain, Clostridium sporogenes was used; this an anaerobic spore-forming bacterium having strong pressure resistance and a putrefactive bacterium. Clostridium sporogenes has been used as the substitute bacterium for Clostridium botulinum in the heat sterilization experiment. Clostridium botulinum is the most important microorganisms from the standpoint of food safety because of the production of strong toxin and is an anaerobic spore-forming bacterium having very strong pressure resistance.

### <Preparation of Test Bacterial Liquid>

Clostridium sporogenes (NBRC14293) was inoculated into 5 mL of TP medium (5% trypticase peptone, 0.5% Bacto peptone, and 0.125% dipotassium hydrogen phosphate, pH: 7.5) and cultured at 35° C. overnight (first culture bacterial liquid). Then, 1 mL of the first culture bacterial liquid was transferred into 9 mL of new TP medium and cultured for 4 hours (second culture bacterial liquid). Subsequently, 10 mL of the second culture bacterial liquid was transferred into 90 mL of new TP medium and cultured for 4 hours (third culture bacterial liquid). At last, 100 mL of the third culture bacterial liquid was transferred into 900 mL of new TP medium and cultured for 2 days (fourth culture bacterial liquid). All cultures were carried out under anaerobic conditions. Only for the last 2 days, the deoxygenation with the use of Ageless (FX, Mitsubishi Gas Chemical Company, Inc., Tokyo) was carried out. In other cases, the gas substitution (10% hydrogen+10% carbon dioxide+80% nitrogen) was carried out. The fourth culture bacterial liquid was confirmed, with a microscope, to have formed spores. Then, the centrifugation (12000 rpm at 4° C. for 10 minutes) was carried out to precipitate the bacterium. The supernatant was discarded, and the precipitate was washed by adding 30 mL of sterilized distilled water. The washing was repeated five times. After washing, the bacterial liquid was dispensed into 15 mL centrifuge tubes in 5 mL fractions and stored at −16° C. in a frozen state. The frozen bacterial liquid was thawed by immersing in a warm bath at 30° C. for 10 minutes and dispensed into 100 μL PCR tubes. Then, the vegetative cells were killed by heating at 80° C. for 10 minutes. The bacterial liquid was cooled to 4° C., placed back in the freezer at −16° C., and stored in a frozen state.

### <Test Method>

Into a flexible pouch, 1 mL of phosphate buffer solution (pH 7.0) and 10 μL of the above-prepared Clostridium sporogenes bacterial liquid were placed, one amino acid out of alanine, arginine, asparagine, aspartic acid, cysteine, glutamine, glutamic acid, glycine, histidine, hydroxyproline, isoleucine, leucine, lysine, methionine, phenylalanine, proline, serine, threonine, and valine was added so that the concentration would be 0.08 mol/L, the pouch was heat-sealed so that air would not go in, and the treatment was carried out under various treatment conditions described below.

From each pouch after the above-described treatment, a solution containing Clostridium sporogenes was separated and suitably diluted with 0.85% physiological saline. The diluted solution and the clostridia count agar (Nissui Pharmaceutical Co., Ltd., Tokyo) from which agar was removed were mixed in a test tube in the ratio of 1:1, an aluminum cap was placed, and the culture was carried out under anaerobic conditions for 4 days at 35° C. The bacterial count was measured by the five-tube most probable number method.

From the thus measured post-treatment bacterial count and the initial bacterial count, log (N [post-treatment bacterial count]/N0 [initial bacterial count]) was calculated to obtain the sterilization effect.

### <Treatment Conditions>

The treatment was carried out under the following conditions.

### Example 1-1

Various amino acids were added, respectively, so that the concentration would be 0.08 mol/L, and the heat treatment was carried out at 80° C. for 10 minutes after the high-pressure treatment at 100 MPa and 45° C. for 120 minutes.

### Example 1-2

Various amino acids were added, respectively, so that the concentration would be 0.08 mol/L, and the heat treatment was carried out at 80° C. for 10 minutes after the high-pressure treatment at 200 MPa and 45° C. for 120 minutes.

### Example 1-3

Various amino acids were added, respectively, so that the concentration would be 0.08 mol/L, and the heat treatment was carried out at 80° C. for 10 minutes after the high-pressure treatment at 400 MPa and 45° C. for 120 minutes.

### Example 1-4

Various amino acids were added, respectively, so that the concentration would be 0.08 mol/L, and the heat treatment was carried out at 80° C. for 10 minutes after the high-pressure treatment at 0.1 MPa and 45° C. for 120 minutes.

For comparison, the similar tests to the above-described Examples 1-1 to 1-4 were carried out without the addition of amino acid.

### <Test Results>

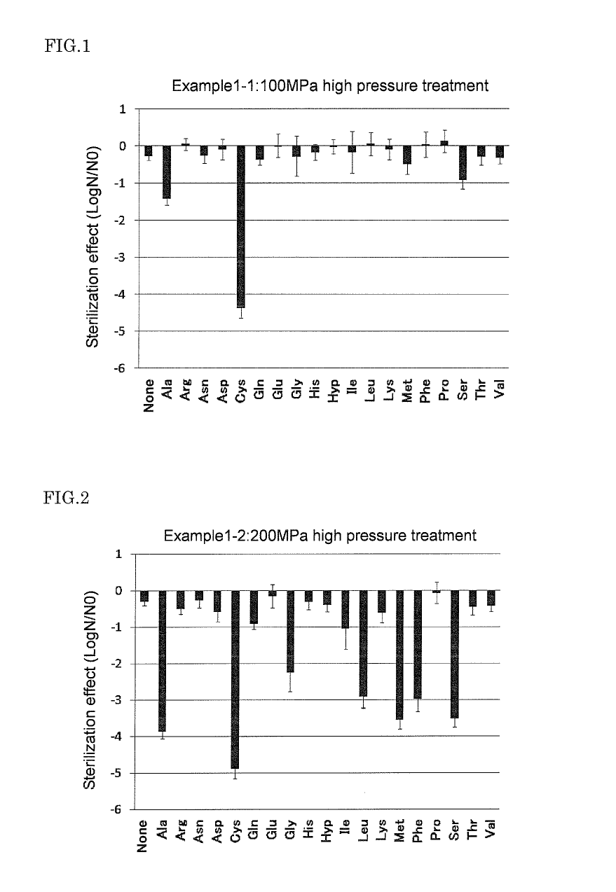

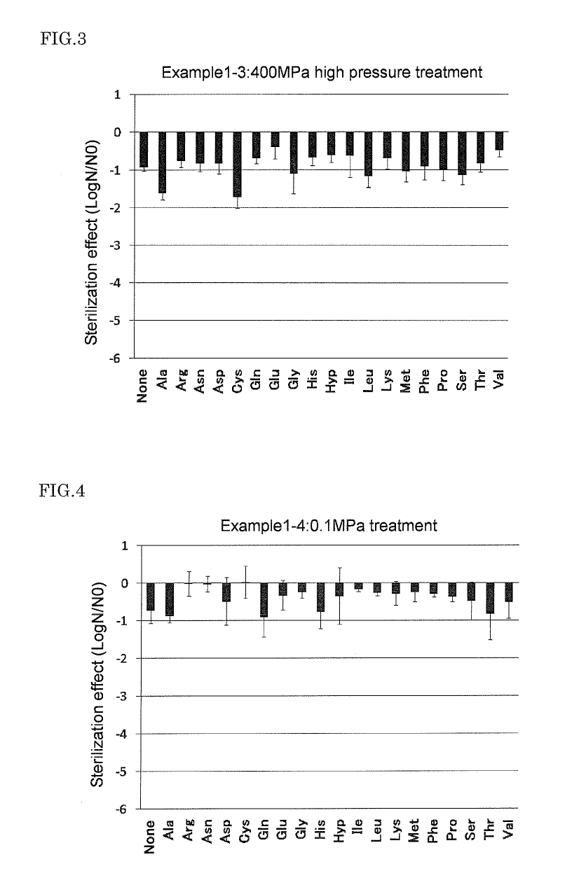

The test results for Examples 1-1 to 1-4 are shown in Table 1 and FIGS. 1 to 4, respectively.

TABLE 1

| | Sterilization effect (LogN/N0) | | | |
|---|---|---|---|---|
| | Example 1-1 | Example 1-2 | Example 1-3 | Example 1-4 |
| Amino | 100 MPa | 200 MPa | 400 MPa | 0.1 MPa |
| acid | treatment | treatment | treatment | treatment |
| None | −0.268 | −0.296 | −0.917 | −0.725 |
| Ala | −1.401 | −3.869 | −1.599 | −0.869 |
| Arg | 0.045 | −0.492 | −0.764 | −0.019 |
| Asn | −0.251 | −0.263 | −0.827 | −0.029 |
| Asp | −0.093 | −0.577 | −0.825 | −0.485 |
| Cys | −4.354 | −4.874 | −1.713 | 0.022 |
| Gln | −0.360 | −0.911 | −0.686 | −0.911 |
| Glu | 0.011 | −0.152 | −0.388 | −0.328 |
| Gly | −0.276 | −2.242 | −1.091 | −0.246 |
| His | −0.170 | −0.304 | −0.656 | −0.756 |
| Hyp | −0.020 | −0.390 | −0.601 | −0.353 |
| Ile | −0.170 | −1.043 | −0.622 | −0.161 |
| Leu | 0.052 | −2.911 | −1.15 | −0.255 |
| Lys | −0.093 | −0.608 | −0.684 | −0.281 |
| Met | −0.492 | −3.538 | −1.034 | −0.242 |
| Phe | 0.037 | −2.980 | −0.908 | −0.294 |
| Pro | 0.125 | −0.069 | −0.982 | −0.360 |
| Ser | −0.914 | −3.511 | −1.127 | −0.483 |
| Thr | −0.280 | −0.449 | −0.829 | −0.828 |
| Val | −0.305 | −0.414 | −0.477 | −0.510 |

As shown in Table 1 and FIGS. 1 to 4, when the high-pressure treatment and low-temperature heat treatment were carried out without the addition of amino acid, the bacterial count did not decrease more than one order of magnitude in all cases. When the high-pressure treatment and low-temperature heat treatment were carried out with the addition of cysteine, alanine, serine, methionine, phenylalanine, glycine, or leucine at the concentration of 0.08 M (Examples 1-1 to 1-3), the bacterial count decreased one order of magnitude or more. More specifically, the decrease was four orders of magnitude or more with cysteine, three orders of magnitude or more with alanine, serine, or methionine, and two orders of magnitude or more with phenylalanine, glycine, or leucine. On the other hand, in the case of Example 1-4, in which the high-pressure treatment was not carried out, the decrease in the viable bacterial count was not observed either with or without the addition of amino acid. Because the spores are not killed by the low-temperature heat treatment at 80° C. for 10 minutes, it is considered that the germination was synergistically promoted by the presence of amino acid and the high-pressure treatment and that the germinated vegetative cells were sterilized by the subsequent low-temperature heat treatment. Among Examples 1-1 to 1-3, in which the high-pressure treatment at 100 to 400 MPa and the low-temperature heat treatment were carried out, the highest sterilization effect was achieved in Example 1-2, in which the treatment was at 200 MPa.

Subsequently, the optimum temperature for the high-pressure treatment was investigated by conducting similar tests varying the temperature for the high-pressure treatment in the presence of one of four kinds of amino acids (alanine, glycine, cysteine, or serine), which were effective for the improvement of the sterilization in the above-described tests.

### <Test Method>

Similarly to the above Example 1, one of the above-described amino acids (alanine, glycine, cysteine, and serine) was added, so that the concentration would be 0.08 mol/L, into a pouch in which Clostridium sporogenes bacterial liquid and a buffer solution were enclosed. The high-pressure treatment was carried out at 20 to 70° C. (20, 45, and 70° C.) and at 100 to 200 MPa (100 MPa and 200 MPa) for 120 minutes, and then the low-temperature heat treatment was carried out at 80° C. for 10 minutes.

As comparative tests, the similar tests to the above-described tests were carried out at a low-pressure (0.1 MPa, 20 to 70° C., 120 minutes) and with the absence of amino acid.

### <Test Results>

The test results for the sterilization effect when the treatment was carried out at the above-described temperatures and pressures are shown in Table 2.

TABLE 2

| Temperature | Pressure | Sterilization effect (logN/N0) | | | | |
|---|---|---|---|---|---|---|
| (° C.) | (MPa) | Ala | Gly | Cys | Ser | None |
| 20 | 0.1 | −0.5 | −0.6 | 0.1 | −0.2 | 0.0 |
| | 100 | −0.8 | −1.1 | −0.4 | −0.2 | −1.2 |
| | 200 | −0.8 | −1.5 | −0.0 | −0.9 | −1.6 |
| 45 | 0.1 | −0.6 | −0.4 | −0.3 | −0.2 | −0.1 |
| | 100 | −3.2 | −1.5 | −4.8 | −1.6 | −0.2 |
| | 200 | −4.8 | −3.1 | −4.7 | −4.1 | −0.4 |
| 70 | 0.1 | −0.6 | −0.3 | −0.2 | −0.3 | −0.1 |
| | 100 | −4.6 | −0.9 | −5.1 | −3.4 | −0.5 |
| | 200 | <−5.5 | −5.4 | <−5.5 | <−5.5 | −0.8 |

As shown in Table 2, the sterilization effect was small when the high-pressure treatment was carried out at 20° C. regardless of the addition of the respective four kinds of amino acids described above. The decrease in the viable bacterial count was about one to two orders of magnitude. When the high-pressure treatment was carried out at 45° C., the improvement in sterilization by the addition of amino acid was prominent. Especially when alanine or cysteine was added and the high-pressure treatment was carried out at 100 to 200 MPa, the viable bacterial count decreased three to five orders of magnitude. When the high-pressure treatment was carried out at 70° C., the sterilization by the addition of amino acid improved further. Especially when the high-pressure treatment was carried out at 200 MPa, the viable bacterial count decreased five orders of magnitude or more.

Subsequently, the preferable pressure for the high-pressure treatment was investigated by varying the pressure in the similar test.

### <Test Method>

Similarly to the above Example 1, one of the three kinds of amino acids (alanine, glycine, and cysteine) was added, so that the concentration would be 0.08 mol/L, into a pouch in which Clostridium sporogenes bacterial liquid and a buffer solution were enclosed. The high-pressure treatment was carried out at 25 to 600 MPa (25, 50, 100, 200, 400, 500, and 600 MPa) and at 70° C. for 120 minutes, and then the heat treatment was carried out at 80° C. for 10 minutes.

### <Test Results>

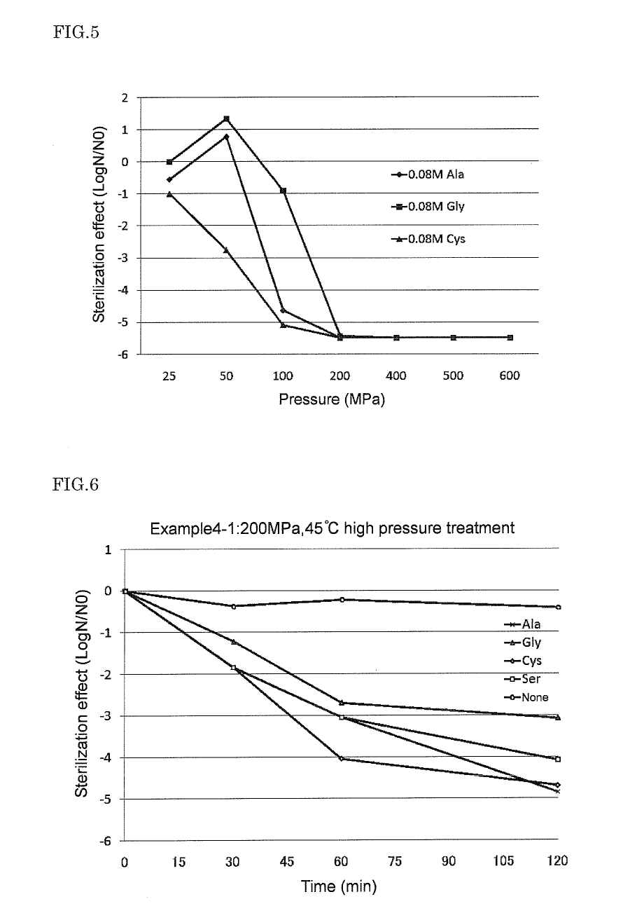

The test results for the sterilization effect when the treatment was carried out at the above-described pressures are shown in Table 3 and FIG. 5.

TABLE 3

| Pressure | Sterilization effect (logN/N0) | | |
|---|---|---|---|
| (MPa) | Ala | Gly | Cys |
| 25 | −0.545 | 0.00 | −1.00 |
| 50 | 0.784 | 1.333 | −2.752 |
| 100 | −4.62 | −0.904 | −5.083 |
| 200 | <−5.481 | −5.435 | <−5.481 |
| 400 | <−5.481 | <−5.481 | <−5.481 |
| 500 | <−5.481 | <−5.481 | <−5.481 |
| 600 | <−5.481 | <−5.481 | <−5.481 |

As shown in the above Table 3 and FIG. 5, the viable bacterial count after the low-temperature heat treatment decreased with the increase in pressure. When cysteine was added, the distinct sterilization effect was achieved at 50 MPa or higher. At 50 MPa, the decrease of about three orders of magnitude was observed, and at 100 to 600 MPa, the decrease of five orders of magnitude or more was observed. When alanine or glycine was added, no effect was observed at 50 MPa. In the case of alanine, however, the sterilization effect of five orders of magnitude or more was achieved at 100 MPa or higher. In the case of glycine, the sterilization effect of five orders of magnitude or more was achieved at 200 MPa or higher.

In addition, the preferable treatment time was investigated by varying the high-pressure treatment time in the similar test.

### <Test Method>

### Example 4-1

Similarly to the above Example 1, one of the four kinds of amino acids (alanine, glycine, cysteine, and serine) was added, so that the concentration would be 0.08 mol/L, into a pouch in which Clostridium sporogenes bacterial liquid and a buffer solution were enclosed. The high-pressure treatment was carried out at 200 MPa and 45° C. for 30 to 120 minutes (30, 60, and 120 minutes), and then the heat treatment was carried out at 80° C. for 10 minutes.

### Example 4-2

Similarly to the above-described test, the high-pressure treatment of the pouch containing Clostridium sporogenes bacterial liquid and one of four kinds of amino acids was carried out at 200 MPa and 70° C. for 10 to 120 minutes (10, 15, 30, 60, and 120 minutes), and then the heat treatment was carried out at 80° C. for 10 minutes.

### <Test Results>

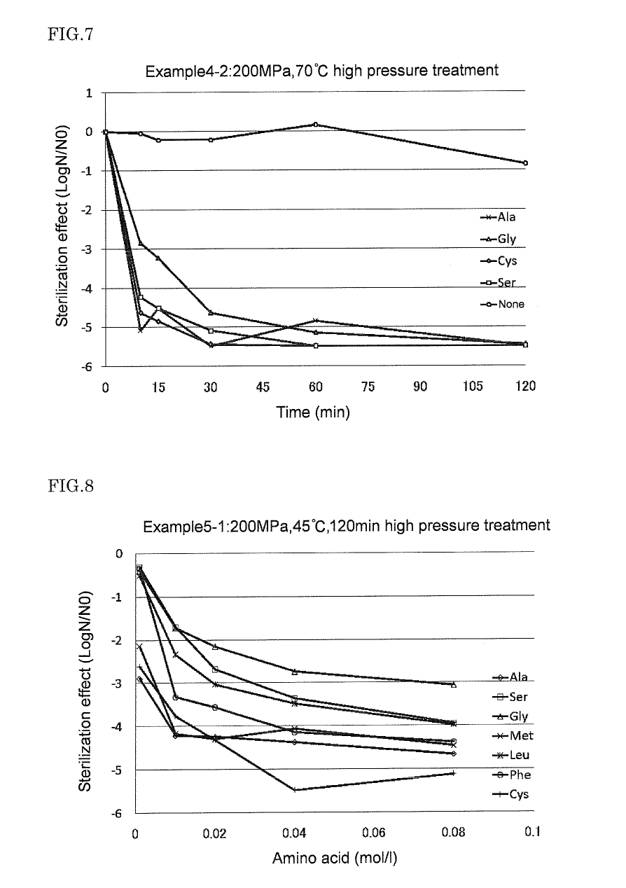

The test results for the above-described Example 4-1 are shown in Table 4 and FIG. 6, and the test results for the above-described Example 4-2 are shown in Table 5 and FIG. 7.

TABLE 4
Example 4-1: 200 MPa, 45° C. high-pressure treatment

| Time | Sterilization effect (logN/N0) | | | | |
|---|---|---|---|---|---|
| (min) | Ala | Gly | Cys | Ser | None |
| 30 | −1.839 | −1.218 | −1.839 | −1.839 | −0.375 |
| 60 | −3.046 | −2.695 | −4.046 | −3.046 | −0.218 |
| 120 | −4.844 | −3.073 | −4.695 | −4.073 | −0.414 |

TABLE 5
Example 4-2: 200 MPa, 70° C. high-pressure treatment

| Time | Sterilization effect (logN/N0) | | | | |
|---|---|---|---|---|---|
| (min) | Ala | Gly | Cys | Ser | None |
| 10 | −5.083 | −2.839 | −4.622 | −4.218 | −0.046 |
| 15 | −4.506 | −3.218 | −4.844 | −4.506 | −0.218 |
| 30 | <−5.481 | −4.622 | −5.435 | −5.083 | −0.218 |
| 60 | <−5.481 | −5.134 | <−5.481 | <−5.481 | 0.161 |
| 120 | <−5.481 | −5.435 | <−5.481 | <−5.481 | −0.839 |

As shown in the above Table 4 and FIG. 6, when the high-pressure treatment was carried out at 200 MPa and 45° C., the post-treatment viable bacterial count decreased with the increase in the high-pressure treatment time. When cysteine was added, the viable bacterial count decreased about four orders of magnitude after 60 minutes. When alanine or serine was added, the viable bacterial count decreased four orders of magnitude or more after 120 minutes. When glycine was added, the viable bacterial count decreased about three orders of magnitude after 60 minutes.

As shown in the above Table 5 and FIG. 7, when the high-pressure treatment was carried out at 200 MPa and 70° C., the viable bacterial count decreased in a very short time compared with the high-pressure treatment at 200 MPa and 45° C. When alanine, cysteine, or serine was added, the decrease of about five orders of magnitude was observed after 30 minutes. When glycine was added, the decrease of about five orders of magnitude was observed after 60 minutes.

In addition, the preferable amino acid concentration for the high-pressure treatment was investigated by varying the amino acid concentration in the similar test.

### <Test Method>

### Example 5-1

Similarly to the above Example 1, one of seven kinds of amino acids (alanine, serine, glycine, methionine, leucine, phenylalanine, and cysteine), which were effective in the above Example 1, was added, so that the concentration would be 0.001 to 0.08 mol/L, into a pouch in which Clostridium sporogenes bacterial liquid and a buffer solution were enclosed. The high-pressure treatment was carried out at 200 MPa and 45° C. for 120 minutes, and then the low-temperature heat treatment was carried out at 80° C. for 10 minutes.

### Example 5-2

Similarly to the above-described test, the high-pressure treatment of the pouch containing Clostridium sporogenes bacterial liquid and one of seven kinds of amino acids at various concentrations was carried out at 200 MPa and 70° C. for 15 minutes, and then the low-temperature heat treatment was carried out at 80° C. for 10 minutes.

### <Test Results>

The test results for the above-described Example 5-1 are shown in Table 6 and FIG. 8, and test results for the above-described Example 5-2 are shown in Table 7 and FIG. 9.

TABLE 6
Example 5-1: 200 MPa, 45° C., 120 min high-pressure treatment

| Amino acid | Sterilization effect(logN/N0) | | | | | | |
|---|---|---|---|---|---|---|---|
| (mol/l) | Ala | Ser | Gly | Met | Leu | Phe | Cys |
| 0.001 | −2.893 | −0.322 | −0.405 | −2.144 | −0.520 | −0.348 | −2.611 |
| 0.01 | −4.213 | −1.697 | −1.725 | −4.169 | −2.338 | −3.319 | −3.758 |
| 0.02 | −4.246 | −2.680 | −2.156 | −4.295 | −3.030 | −3.560 | −4.315 |
| 0.04 | −4.372 | −3.362 | −2.743 | −4.063 | −3.483 | −4.144 | −5.48 |
| 0.08 | −4.659 | −3.942 | −3.064 | −4.456 | −3.977 | −4.377 | −5.12 |

Example 5-2: 200 MPa, 70° C., 15 min high-pressure treatment

| Amino acid | Sterilization effect(logN/N0) | | | | | | |
|---|---|---|---|---|---|---|---|
| (mol/l) | Ala | Ser | Gly | Met | Leu | Phe | Cys |
| 0.001 | −2.387 | −0.656 | −0.583 | −1.170 | −0.372 | −0.528 | −0.583 |
| 0.01 | −3.686 | −1.264 | −1.090 | −2.919 | −0.694 | −0.842 | −2.584 |
| 0.02 | −4.160 | −1.945 | −1.697 | −3.481 | −1.473 | −2.366 | −4.110 |
| 0.04 | −4.270 | −2.641 | −2.686 | −3.618 | −1.838 | −2.641 | −4.213 |
| 0.08 | −4.043 | −3.449 | −2.681 | −4.019 | −2.502 | −3.202 | −5.100 |

As shown in the above Table 6 and FIG. 8, when the high-pressure treatment was carried out at 200 MPa and 45° C. for 120 minutes, the sterilization effect improved with the increase in the amino acid concentration up to 0.01 or 0.02 mol/L. However, when the concentration was higher than these values, the sterilization effect hardly increased though the decrease was not observed either.

As shown in the above Table 7 and FIG. 9, when the high-pressure treatment was carried out at 200 MPa and 70° C. for 15 minutes, the sterilization effect hardly changed at the higher amino acid concentrations than 0.01 or 0.02 mol/L, as was the case when the high-pressure treatment was carried out at 200 MPa and 45° C. for 120 minutes. Thus, the preferable amino acid concentration is considered to be 0.01 to 0.02 mol/L.

Subsequently, the synergistic effect of amino acid and sodium hydrogencarbonate (NaHCO₃) was investigated by carrying out the high-pressure treatment by adding sodium hydrogencarbonate as well as an amino acid.

### <Test Method>

### Example 6-1

Similarly to the above Example 1, (1) 0.08 mol/L of glycine, (2) 0.08 mol/L of glycine and 0.4 mol/L of sodium hydrogencarbonate, or (3) 0.4 mol/L of sodium hydrogencarbonate was added into a pouch in which Clostridium sporogenes bacterial liquid and a buffer solution were enclosed. The high-pressure treatment was carried out at 100 MPa and 70° C. for 15 minutes, and then the low-temperature heat treatment was carried out at 80° C. for 10 minutes. In case (1), the pH was adjusted to 8.4 so that the pH is the same as the case of 0.4 mol/L of sodium hydrogencarbonate.

### Example 6-2

Similarly to the above-described test, 0.08 mol/L of glycine and/or 0.4 mol/L of sodium hydrogencarbonate was added to Clostridium sporogenes bacterial liquid under the conditions of (1) to (3). The high-pressure treatment was carried out at 200 MPa and 70° C. for 15 minutes, and then the low-temperature heat treatment was carried out at 80° C. for 10 minutes.

### <Test Results>

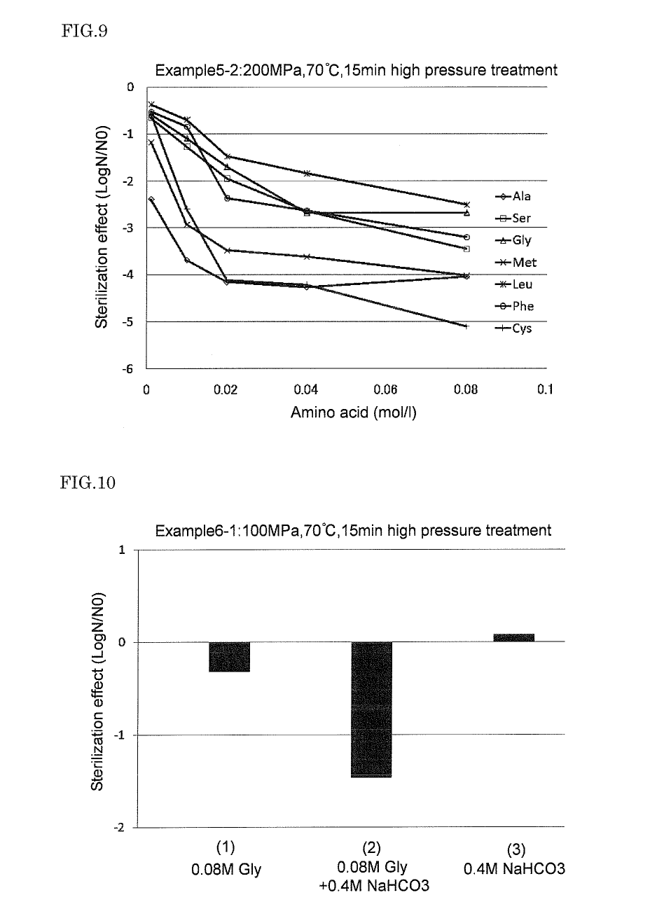

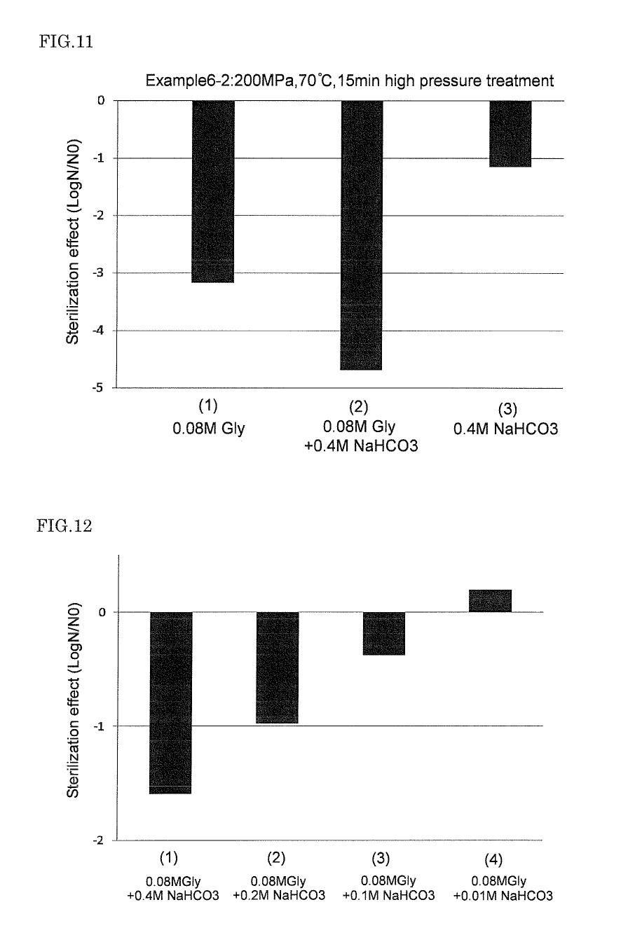

The test results for the above-described Example 6-1 are shown in Table 8 and FIG. 10, and the test results for the above-described Example 6-2 are shown in Table 9 and FIG. 11.

TABLE 8
Example 6-1: 100 MPa, 70° C., 15 min high-pressure treatment

| | | (2) 0.08M Gly + | (3) 0.4M |
|---|---|---|---|
| | (1) 0.08M Gly | 0.4M NaHCO₃ | NaHCO₃ |
| Sterilization effect | −0.32034 | −1.4641 | 0.08543 |
| (Log(N/N0) | | | |

TABLE 9
Example 6-2: 200 MPa, 70° C., 15 min high-pressure treatment

| | | (2) 0.08M Gly + | (3) 0.4M |
|---|---|---|---|
| | (1) 0.08M Gly | 0.4M NaHCO₃ | NaHCO₃ |
| Sterilization effect | −3.17609 | −4.68601 | −1.15679 |
| (Log(N/N0) | | | |

As shown in the above Table 8 and FIG. 10, when the high-pressure treatment was carried out at 100 MPa and 70° C. for 15 minutes, the sterilization effect was hardly obtained by the addition of (1) glycine alone. In addition, the sterilization effect was not obtained at all by the addition of (3) sodium hydrogencarbonate alone. However, the bacterial count decreased one to two orders of magnitude by the (2) simultaneous use of both compounds. In the case of the addition of (1) glycine alone, the pH was adjusted to 8.4, which is a similar pH to the case of the addition of 0.4 M sodium hydrogencarbonate; however, the germination of spores did not take place. Therefore, the germination promoting effect by the simultaneous use of glycine and sodium hydrogencarbonate is not simply due to the adjustment of pH.

On the other hand, when the high-pressure treatment was carried out at 200 MPa and 70° C. for 15 minutes as shown in the above Table 9 and FIG. 11, the bacterial count decreased one order of magnitude by the addition of (3) sodium hydrogencarbonate alone. By the addition of (1) glycine alone, the bacterial count decreased about three orders of magnitude. In contrast, the bacterial count decreased four to five orders of magnitude or more by the (2) simultaneous use of both compounds. Thus it was clarified that the sterilization effect of the high-pressure treatment/low-temperature heat treatment is synergistically promoted by the simultaneous use of glycine and sodium hydrogencarbonate.

In addition, the preferable concentration of sodium hydrogencarbonate was investigated by carrying out the similar tests varying the concentration of sodium hydrogencarbonate in the high-pressure treatment.

### <Test Method>

Similarly to the above Example 1, 0.08 mol/L of glycine was added into a pouch in which Clostridium sporogenes bacterial liquid and a buffer solution were enclosed, and (1) 0.4 mol/L of sodium hydrogencarbonate, (2) 0.2 mol/L of sodium hydrogencarbonate, (3) 0.1 mol/L of sodium hydrogencarbonate, or (4) 0.01 mol/L of sodium hydrogencarbonate was added. The high-pressure treatment was carried out at 100 MPa and 70° C. for 15 minutes, and then the low-temperature heat treatment was carried out at 80° C. for 10 minutes.

### <Test Results>

The test results for the sterilization effect when the treatment was carried out at the above-described concentrations are shown in Table 10 and FIG. 12.

TABLE 10

| | (1) 0.08M | (2) 0.08M | (3) 0.08M | (4) 0.08M |
|---|---|---|---|---|
| | Gly + 0.4M | Gly + 0.2M | Gly + 0.1M | Gly + 0.01M |
| | NaHCO₃ | NaHCO₃ | NaHCO₃ | NaHCO₃ |
| Sterilization | −1.59373 | −0.97285 | −0.37742 | 0.198834 |
| effect | | | | |
| (Log(N/N0) | | | | |

As shown in the above Table 10 and FIG. 12, when 0.01 mol/L or 0.1 mol/L of sodium hydrogencarbonate was added in addition to 0.08 mol/L of glycine, the sterilization effect was not improved. However, when 0.2 mol/L or higher sodium hydrogencarbonate was added, the sterilization effect was improved one order of magnitude or more.

Subsequently, the sterilization effect in food was investigated. Sodium hydrogencarbonate was added to the food containing a large amount of free amino acids, or an amino acid and sodium hydrogencarbonate were simultaneously added to the food containing a relatively small amount of amino acids; then the high-pressure treatment was carried out.

### <Test Method>

### Example 8-1

### Hashed Beef Rice (High-Pressure Treatment at 200 MPa)

(1) The sample with sodium hydrogencarbonate was prepared by placing 1 mL of hashed beef rice in a flexible pouch, adding sodium hydrogencarbonate so that the concentration is 0.4 mol/L, inoculating 10 μL of Clostridium sporogenes spores, and heat-sealing the pouch. The high-pressure treatment was carried out at 200 MPa and 70° C. for 15 minutes, and the heat treatment was carried out at 80° C. for 10 minutes. (2) The sample without sodium hydrogencarbonate was prepared by placing 1 mL of hashed beef rice in a flexible pouch, adjusting the pH to 8.4, which is the same pH as that when sodium hydrogencarbonate was added, inoculating 10 μL of Clostridium sporogenes spores, and heat-sealing the pouch. The high-pressure treatment was carried out at 200 MPa and 70° C. for 15 minutes, and then the heat treatment was carried out at 80° C. for 10 minutes.

### Example 8-2

### Hashed Beef Rice (High-Pressure Treatment at 100 MPa)

Under similar conditions to those of the above-described Example 8-1, the high-pressure treatment was carried out at 100 MPa and 70° C. for 15 minutes, and then the heat treatment was carried out at 80° C. for 10 minutes.

### Example 8-3

### Burdock (High-Pressure Treatment at 200 MPa)

(1) The sample with amino acid was prepared by immersing 1 g of burdock in Clostridium sporogenes spore liquid (5.4×10⁵ spores/mL), washing the microorganisms present around the burdock with sterilized distilled water, air-drying, adding alanine so that the concentration is 0.08 mol/L, and immersing in the soak solution whose pH is adjusted to 8.4, which is the same pH as that when sodium hydrogencarbonate was added. The high-pressure treatment was carried out at 200 MPa and 70° C. for 15 minutes, and then the heat treatment was carried out at 80° C. for 10 minutes. (2) The sample with sodium hydrogencarbonate and amino acid was prepared by immersing 1 g of burdock in Clostridium sporogenes spore liquid (5.4×10⁵ spores/mL), washing the microorganisms present around the burdock with sterilized distilled water, air-drying, and immersing in the soak solution that was prepared by adding sodium hydrogencarbonate so that the concentration is 0.4 mol/L and adding alanine so that the concentration is 0.08 mol/L. The high-pressure treatment was carried out at 200 MPa and 70° C. for 15 minutes, and then the heat treatment was carried out at 80° C. for 10 minutes. (3) The sample with sodium hydrogencarbonate was prepared by immersing 1 g of burdock in Clostridium sporogenes spore liquid (5.4×10⁵ spores/mL), washing the microorganisms present around the burdock with sterilized distilled water, air-drying, and immersing in the soak solution that was prepared by adding sodium hydrogencarbonate so that the concentration is 0.4 mol/L. The high-pressure treatment was carried out at 200 MPa and 70° C. for 15 minutes, and then the heat treatment was carried out at 80° C. for 10 minutes.

### Example 8-4

### Burdock (High-Pressure Treatment at 100 MPa)

Under similar conditions to those of the above-described Example 8-3, the high-pressure treatment was carried out at 100 MPa and 70° C. for 15 minutes, and then the heat treatment was carried out at 80° C. for 10 minutes.

### <Test Results>

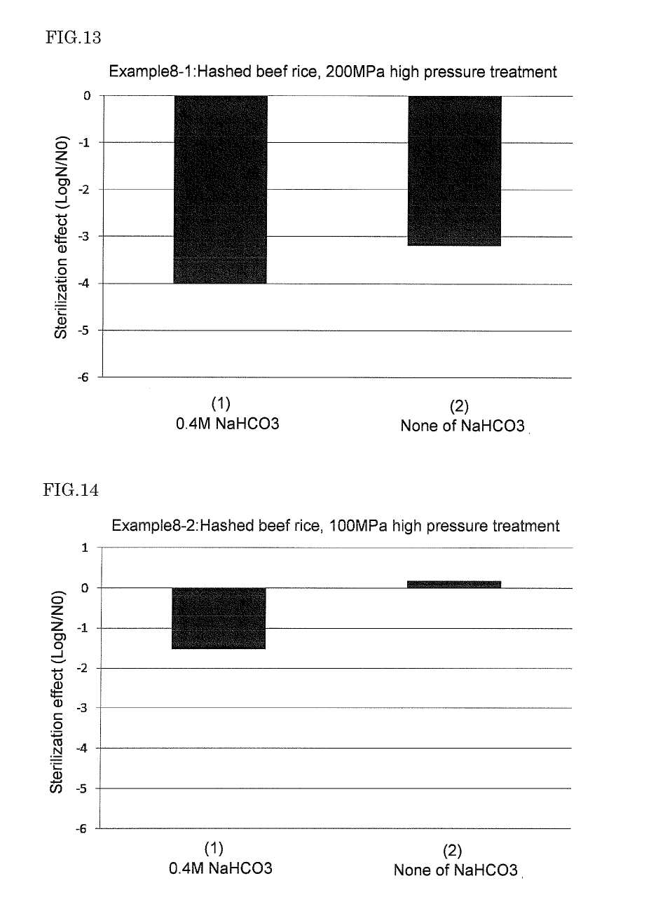

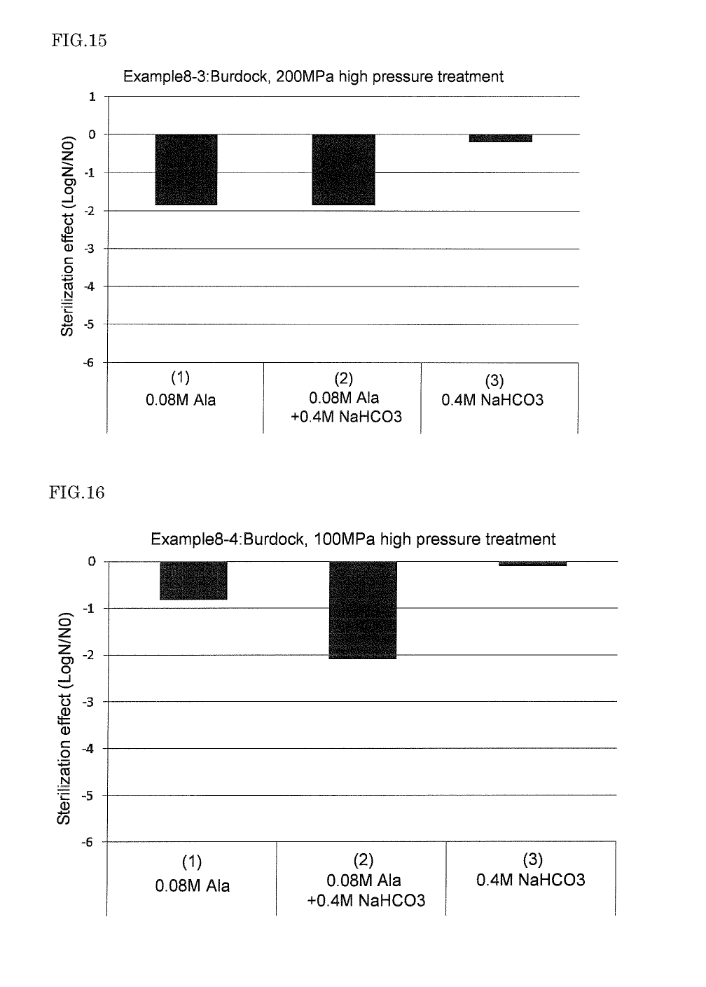

The test results for the above-described Examples 8-1 and 8-2 are shown in Table 11 and FIGS. 13 and 14, and the test results for the above-described Examples 8-3 and 8-4 are shown in Table 12 and FIGS. 15 and 16.

TABLE 11

| | (1) 0.4M | (2) None of |
|---|---|---|
| Hashed beef rice | NaHCO₃ | NaHCO₃ |
| Example 8-1 | −4 | −3.18906 |
| (200 MPa) | | |
| Example 8-2 | −1.52288 | 0.189056 |
| (100 MPa) | | |

TABLE 12

| | | (2) 0.08M Ala + | (3) 0.4M |
|---|---|---|---|
| Burdock | (1) 0.08M Ala | 0.4M NaHCO₃ | NaHCO₃ |
| Example 8-3 | <−1.84946 | <−1.84946 | −0.20711 |
| (200 MPa) | | | |
| Example 8-4 | −0.82391 | <−2.08715 | −0.11197 |
| (100 MPa) | | | |

As shown in Table 11 and FIGS. 13 and 14, when the high-pressure treatment of the hashed beef rice, which contains a large amount of free amino acids, was carried out at 200 MPa an 70° C. for 15 minutes, the sterilization effect of four orders of magnitude or more was achieved by the addition of sodium hydrogencarbonate. The improvement of the sterilization effect by the addition of (1) sodium hydrogencarbonate was also confirmed by comparing with the sterilization effect of three orders of magnitude achieved for the (2) sample without sodium hydrogencarbonate. Under the conditions of 100 MPa, 70° C., and 15 minutes, the sterilization effect was not obtained for the (2) sample without sodium hydrogencarbonate. However, the sterilization effect of one to two orders of magnitude was achieved by the addition of (1) sodium hydrogencarbonate.

As shown in Table 12 and FIGS. 15 and 16, when the high-pressure treatment of burdock, which contains a relatively small amount of amino acids, was carried out at 200 MPa and 70° C. for 15 minutes, the sterilization effect was hardly obtained by (3) sodium hydrogencarbonate alone. However, when (1) alanine alone was added or both (2) alanine and sodium hydrogencarbonate were added, the viable bacterial count decreased two orders of magnitude or more to less than the detection limit. On the other hand, when the high-pressure treatment was carried out at 100 MPa and 70° C. for 15 minutes, the addition of (3) sodium hydrogencarbonate alone or the addition of (1) alanine alone was not effective. However, the sterilization effect of two orders of magnitude was achieved by the (2) simultaneous use of alanine and sodium hydrogencarbonate.

### <Test Strains>

Two strains of Clostridium botulinum were used.

### <Preparation of Test Bacterial Liquid>

Clostridium botulinum (C. botulinum) 62A (toxin A-producing strain) and 213B (toxin B-producing strain) were cultured, respectively, in TP medium at 30° C. for 1 day and at room temperature for 3 more days. The formation of spores was confirmed with a phase-contrast microscope, and the washing with sterilized distilled water was repeated five times.

### <Test Method>

### Example 9-1

### C. Botulinum 62A (Toxin A-Producing Strain)

Into a flexible pouch, 1 mL of the treatment solution (pH 7.0) was placed, and then 10 μL of the above prepared Clostridium botulinum (C. botulinum) 62A (toxin A-producing strain) bacterial liquid was placed. The pouch was heat-sealed so that air would not go in, and the treatment was carried out under various conditions described below.

(1) The sample with amino acid was prepared by adding alanine so that the concentration is 0.08 mol/L and adjusting the pH to 7.0. The high-pressure treatment was carried out at 200 MPa and 70° C. for 15 minutes, and then the heat treatment was carried out at 80° C. for 10 minutes.

(2) The sample with sodium hydrogencarbonate and amino acid was prepared by adding sodium hydrogencarbonate so that the concentration is 0.4 mol/L and adding alanine so that the concentration is 0.08 mol/L. The high-pressure treatment was carried out at 200 MPa and 70° C. for 15 minutes, and then the low-temperature heat treatment was carried out at 80° C. for 10 minutes.

(3) The sample with sodium hydrogencarbonate was prepared by adding sodium hydrogencarbonate so that the concentration is 0.4 mol/L. The high-pressure treatment was carried out at 200 MPa and 70° C. for 15 minutes, and then the low-temperature heat treatment was carried out at 80° C. for 10 minutes.

(4) The sample with neither amino acid nor sodium hydrogencarbonate was prepared by omitting their addition and adjusting the pH to 7.0. The high-pressure treatment was carried out at 200 MPa and 70° C. for 15 minutes, and then the low-temperature heat treatment was carried out at 80° C. for 10 minutes.

### Example 9-2

### C. Botulinum 213B (Toxin B-Producing Strain)

Under similar conditions to those of the above-described Example 9-1, the sterilization effect was investigated with the use of Clostridium botulinum 213B (toxin B-producing strain).

### <Test Results>

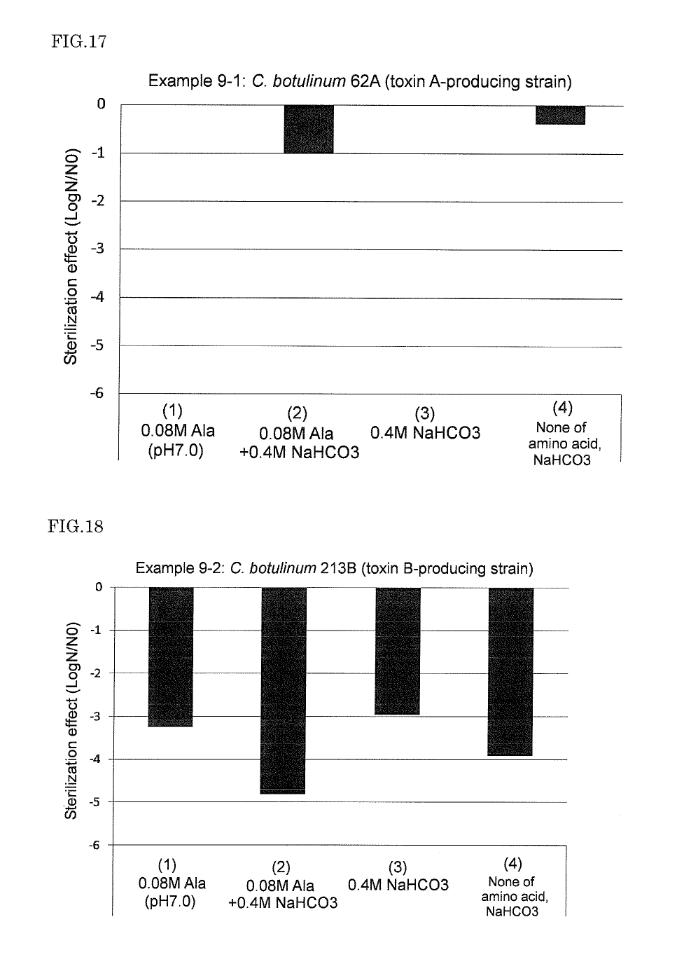

The test results for the above-described Example 9-1 are shown in Table 13 and FIG. 17, and the test results for the above-described Example 9-2 are shown in Table 14 and FIG. 18.

TABLE 13
Example 9-1: C. botulinum 62A (toxin A-producing strain)

| | | | | (4) None of |
|---|---|---|---|---|
| | (1) 0.08M Ala | (2) 0.08M Ala + | (3) 0.4M | amino acid |
| | (pH7.0) | 0.4M NaHCO₃ | NaHCO₃ | and NaHCO₃ |
| Sterilization | −0 | −1 | −0.09691 | −0.38899 |
| effect | | | | |
| (Log(N/N0) | | | | |

TABLE 14
Example 9-2: C. botulinum 213B (toxin B-producing strain)

| | | | | (4) None of |
|---|---|---|---|---|
| | (1) 0.08M Ala | (2) 0.08M Ala + | (3) 0.4M | amino acid |
| | (pH7.0) | 0.4M NaHCO₃ | NaHCO₃ | and NaHCO₃ |
| Sterilization | −3.24864 | −4.81291 | −2.9576 | −3.91897 |
| effect | | | | |
| (Log(N/N0) | | | | |

As shown in Table 13 and FIG. 17, when Clostridium botulinum 62A strain was used, the sterilization effect of one order of magnitude was achieved by the addition of (2) both alanine and sodium hydrogencarbonate; however, a significant sterilization effect was not observed by other treatments. On the other hand, as shown in Table 14 and FIG. 18, when Clostridium botulinum 213B strain was used, the sterilization effect of about three orders of magnitude was observed for the phosphate buffer solution (pH 7.0) containing only the (4) amino acid. The sterilization effect was further improved by the addition of (2) both alanine and sodium hydrogencarbonate, and the viable bacterial count decreased about five orders of magnitude. Thus, it was clarified that the sterilization effect due to high-pressure treatment/low-temperature heat treatment is synergistically promoted, for not only C. sporogenes but also C. botulinum, by the simultaneous use of an amino acid and sodium hydrogencarbonate.

1. A method for sterilization of food comprising:
high-pressure treatment step in which one or more amino acids selected from the group consisting of cysteine, alanine, methionine, phenylalanine, serine, leucine, and glycine is added to a sterilization target food, and then the sterilization target food including the amino acid is treated at 50 to 600 MPa for 1 to 120 minutes; and
low-temperature heating step in which the sterilization target food is heated at 60 to 100° C. for 5 minutes or more after the high-pressure treatment step.

2. The method according to claim 1, wherein 0.01 to 0.15 mol of the amino acid relative to 1 L of the sterilization target food is added.

3. The method according to claim 1, wherein alanine and/or cysteine is used as the amino acid.

4. The method according to claim 1, wherein sodium hydrogencarbonate is added to the sterilization target food with the amino acid.

5. The method according to claim 4, wherein 0.2 to 1.0 mol of the sodium hydrogencarbonate relative to 1 L of the sterilization target food is added.

6. The method according to claim 1, wherein the sterilization target food contains less than 0.15 mol/l of amino acid in total before adding the amino acid.

7. A method for sterilization of food comprising:
high-pressure treatment step in which sodium hydrogencarbonate is added to a sterilization target food containing 0.01 mol/L or more of amino acid in total, and then the sterilization target food including the sodium hydrogencarbonate is treated at 50 to 600 MPa for 1 to 240 minutes; and
low-temperature heating step in which the sterilization target food is heated at 60 to 100° C. for 5 minutes or more after the high-pressure treatment step.

8. The method according to claim 7, wherein 0.2 to 1.0 mol of the sodium hydrogencarbonate relative to 1 L of the sterilization target food is added.

9. The method according to claim 1, wherein spore-forming bacteria in the sterilization target food is sterilized.

10. The method according to claim 9, wherein Clostridium bacteria in the sterilization target food is sterilized.

11. The method according to claim 7 wherein spore-forming bacteria in the sterilization target food is sterilized.

12. The method according to claim 11, wherein Clostridium bacteria in the sterilization target food is sterilized
